(19) United States
(12) Patent Application Publication
(10) Pub. No.: US 2014/0136318 A1
(43) Pub. Date: May 15, 2014

(54) Systems and Methods for Advertising to a Group of Users

(71) Applicant: MOTOROLA MOBILITY LLC, Libertyville, IL (US)

(72) Inventors: William P. Alberth, JR., Prairie Grove, IL (US); William S. Hede, Lake in the Hills, IL (US); Hisashi D. Watanabe, Lake Forest, IL (US)

(73) Assignee: Motorola Mobility LLC, Libertyville, IL (US)

(21) Appl. No.: 13/672,835

(22) Filed: Nov. 9, 2012

(51) Int. Cl. G06Q 30/02

(52) U.S. Cl. 705/14.53

(57) ABSTRACT

Systems and methods are provided for targeting advertisements to a group of proximate electronic devices. According to certain aspects, an electronic device determines (710) a proximity to a second electronic device. The electronic device compares (725) purchase histories associated with the electronic device and the second electronic device to identify an item associated with the electronic device but not with the second electronic device. Further, the electronic device determines (730) that its user has a positive user experience with the item and requests (740) an advertising server to provide an advertisement for the item to the electronic device and/or the second electronic device.

### FIELD

This application generally relates to advertising to a group of users within a proximity of each other. In particular, the application relates to platforms and techniques for providing an advertisement for an item intended to elicit conversation between or among the group of proximate users.

### BACKGROUND

With the increasing prevalence of mobile devices, there has been a growing effort to implement mobile advertising. Various existing techniques for mobile advertising include “promoted” advertisements, whereby advertisers pay an amount to deliver advertisements to a particular group of individuals. Further, various advertisers facilitate targeted advertising whereby advertisements are identified based on a user's likes or dislikes. As another example, various entities target mobile advertisements to a virtual user grouping at a common event or gathering.

There may be other factors to mobile advertising, however, that are not considered. As a result, advertisers may not be reaching a proper audience with relevant or effective advertisements. Further, a user who receives an advertisement may not know anything about the advertised product or service or may not have the ability to find out more information about the advertised product or service. Accordingly, there is an opportunity for improving advertising to a group of users within a proximity to each other.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an example environment including various components for facilitating advertising in accordance with some embodiments.

FIG. 2 depicts a diagram for providing targeted advertisements in accordance with some embodiments.

FIG. 3 depicts a diagram for providing targeted advertisements in accordance with some other embodiments.

FIG. 4 is a block diagram of an electronic device in accordance with some embodiments.

FIG. 5 is a block diagram of a computer system in accordance with some embodiments.

FIG. 6 depicts a flow diagram of targeted advertising in accordance with some embodiments.

FIG. 7 depicts a flow diagram of targeted advertising in accordance with some other embodiments.

### DETAILED DESCRIPTION

Systems and methods provide advertisements to a set of electronic devices within a proximity to each other. More particularly, in response to determining that the electronic devices are in proximity, the systems and methods identify an item associated with one of the electronic devices and determine that the item is not associated with at least one of the other nearby electronic devices. Additionally, the systems and methods identify an advertisement for the identified item and provide the advertisement to one or more of the proximal electronic devices. In aspects, the systems and methods can determine the proximity via an analysis of various sensor, network, and/or location data. Further, the systems and methods can determine the item via an analysis of purchase histories associated with the electronic devices. According to embodiments, the systems and methods verify that the item has a positive user experience with a user of one of the electronic devices, such that the user may be more willing to promote the item to the additional users.

Because of the proximity of the devices when the devices receive the advertisement, the users of the devices can converse about the item after viewing the advertisement. Further, because at least one of the users has a positive experience with the item, that user can describe or promote the item to any other users that do not have the item or may not know much about the item. For example, suppose one user has recently purchased a pair of boots that offers impressive warmth in the cold winter months. If an advertisement for the pair of boots is provided to a group of users including the one user, the one user may be prompted to describe the advantages and the features of the pair of boots to the other users of the group.

The systems and methods offer a benefit to companies or entities wishing to advertise a particular item because there is an improved chance that a user without a particular item, or even with little or no knowledge of the item, may be able to learn about the item by conversing with another user who has a good experience with the item. Further, the systems and methods enable advertisement providers to charge a premium to deliver an advertisement to a group of users that meets these qualifications.

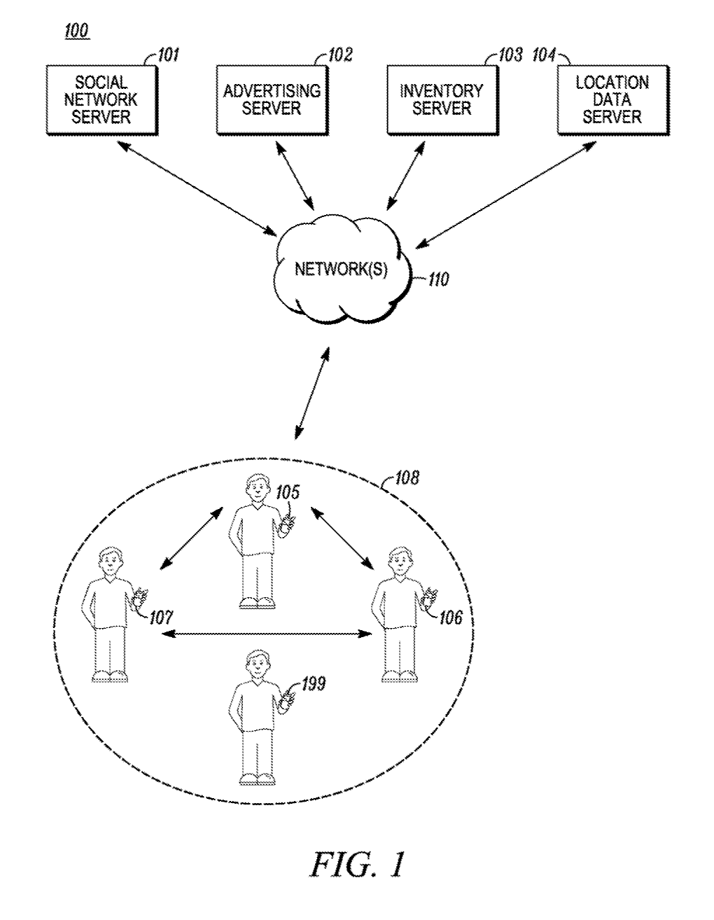

FIG. 1 depicts an environment 100 including various components and entities configured to facilitate the functionalities as described herein. It should be appreciated that the environment 100 is merely an example and can include fewer or more components and entities, as well as other various combinations of components and entities.

As shown in FIG. 1, the environment 100 includes electronic devices 105, 106, 107, 199 configured for use by respective users. Further, the environment 100 includes a social network server 101, an advertising server 102, an inventory server 103, and a location data server 104. The electronic devices 105, 106, 107, 199 can connect to and communicate with any of the social network server 101, the advertising server 102, the inventory server 103, and the location data server 104 via a network 110 such as, for example, a wide area network (WAN), a local area network (LAN), a personal area network (PAN), or other networks. The network 110 can facilitate any type of wireless data communication via any standard or technology (e.g., GSM, CDMA, TDMA, WCDMA, LTE, EDGE, OFDM, GPRS, EV-DO, WiMAX, WiFi, Bluetooth, UWB, and others). It should be appreciated that each of the social network server 101, the advertising server 102, the inventory server 103, and the location data server 104 can connect to and communicate with each other, for example via the network 110. Similarly, each of the electronic devices 105, 106, 107, 199 can connect to and communicate with each other, for example via the network 110.

The components of the environment 100 can implement the systems and methods that facilitate and manage the advertising functionalities. As shown in FIG. 1, there are four electronic devices 105, 106, 107, 199 although it should be appreciated that the functionalities can be implemented with other amounts of electronic devices. According to embodiments, the electronic devices 105, 106, 107 can be associated with each other, and the electronic device 199 is not associated with any of the other electronic devices 105, 106, 107. In certain aspects, the electronic devices 105, 106, 107 and/or the users thereof can be associated to each other via the social network server 101 while the electronic device 199 is not associated with the other electronic devices 105, 106, 107 via the social network server 101. More particularly, the users of the electronic devices 105, 106, 107 can be “connected” to each other or otherwise members of a common group via a social network implemented by the social network server 101. In some cases, the electronic devices 105, 106, 107 can have each other listed in a contacts list (such as a locally-stored contacts list) or other similar connection. It should be appreciated that other types of associations between and among the electronic devices 105, 106, 107 are envisioned.

According to embodiments, each of the associated electronic devices 105, 106, 107 can detect when it is located within a proximity 108 to one or more of the other associated electronic devices 105, 106, 107. For example, the electronic device 105 can detect when it is located in proximity 108 to the electronic devices 106, 107. In certain aspects, the electronic devices 105, 106, 107 can determine proximity 108 when two or more of the electronic devices 105, 106, 107 are connected to the same network. For example, one of the electronic devices 105, 106, 107 can determine that another of the electronic devices 105, 106, 107 is connected to the same wireless LAN (e.g., a Wi-Fi network) or to the same PAN (e.g. a Bluetooth® network). In other aspects, the electronic devices 105, 106, 107 can determine proximity 108 when one of the electronic devices 105, 106, 107 detects another of the electronic devices 105, 106, 107 via a sensor, such as a camera sensor, analyzes the sensor data, and identifies the another electronic device via the analysis.

In further aspects, the electronic devices 105, 106, 107 can determine proximity 108 when one of the electronic devices 105, 106, 107 detects another of the electronic devices 105, 106, 107 via a near field communication (NFC) chip or via radio-frequency identification (RFID). In still further aspects, the electronic devices 105, 106, 107 can determine proximity 108 when the global positioning system (GPS) coordinates of two or more of the electronic devices 105, 106, 107 are equal or approximately equal to each other (e.g., via the Google® Latitude application). In these aspects, the electronic devices 105, 106, 107 can interface with a GPS satellite (not shown in FIG. 1) and/or the location data server 104 to receive location data and analyze the location data to determine proximity 108. It should be appreciated that other techniques for determining proximity 108 are envisioned, and that proximity may be determined by the electronic devices 105, 106, 107, 199 or by the location data server 104.

According to embodiments, each of the electronic devices 105, 106, 107 can have an associated purchase history that can detail one or more products, items, or the like that respective users of the electronic devices 105, 106, 107 have purchased. The inventory server 103 can store the purchase histories associated with the electronic devices 105, 106, 107, and the electronic devices 105, 106, 107 can retrieve the purchase histories from the inventory server 103 via the network 110. In some embodiments, the purchase histories can include data such as electronic wallet application data, any NFC purchase data, credit card transactions, and/or any other data that can indicate product and item purchases. According to some aspects, the electronic devices 105, 106, 107 can locally store or maintain the respective purchase histories in its own memory. For example, if a user of the electronic device 107 makes an NFC purchase for a dress shirt, the electronic device 107 can update its purchase history to reflect the purchase of the dress shirt.

In some embodiments, any of the electronic devices 105, 106, 107 can identify an item via sensor data. In some aspects, an NFC or RFID chip of the device can detect a presence of the item. In other aspects, an imaging sensor of the device can capture image data of the item and the device can perform an object recognition algorithm on the image data to identify or determine the item (e.g., via Google® Goggles application). For example, a user can use electronic device 105 to capture an image of a pair of sunglasses, and the electronic device 105 can process the image data and identify the sunglasses as being a particular model of a particular brand. In embodiments, the electronic devices 105, 106, 107 can examine associated purchase inventories to determine which of the purchase inventories include the identified item. Referring back to the example, a purchase history of the electronic device 105 may list the specific sunglasses, but the purchase histories of the electronic devices 106, 107 may not list the specific sunglasses, thus indicating that the user of electronic device 105 has purchased the sunglasses while the users of electronic devices 106 and 107 have not purchased the sunglasses.

Each of the electronic devices 105, 106, 107 can interface with the advertising server 102 to identify and provide relevant advertisements to one or more of the electronic devices 105, 106, 107. In particular, the advertisements are associated with the items contained in the purchase histories of the electronic devices 105, 106, 107. According to aspects, the advertising server 102 and/or the electronic devices 105, 106, 107 can (1) identify an item in one of the purchase histories and (2) determine that this item is not included in at least one of the remaining purchase histories. For example, the purchase history of the electronic device 105 may indicate a purchase of a certain pair of shoes, and the purchase history of the electronic device 106 may not include this certain pair of shoes. In this example, the electronic device 105 may use an NFC chip to determine that the user of the electronic device 105 is wearing the shoes. For further example, data from the inventory server 103 may indicate that a user of one of the electronic devices 105, 106, 107 has recently purchased a specific car, and data from the location data server 104 may indicate that another user of another of the electronic devices 105, 106, 107 has recently visited one or more car dealerships, perhaps indicating that the another user is in the market for a car (and presumably that the another user does not have the specific car).

In some aspects, the advertising server 102 and/or the electronic devices 105, 106, 107 may identify or determine an item before examining the purchase histories of the electronic devices 105, 106, 107. For instance, a company offering a particular wristwatch may request the advertising server 102 to determine a group of electronic devices where one of the electronic devices has an association with the wristwatch and one of the electronic devices does not have the association with the wristwatch. In these cases, the advertising server 102 and/or the associated electronic devices 105, 106, 107 in a proximal location can identify the item and then examine the purchase histories of the electronic devices 105, 106, 107 to determine whether one of the purchase histories includes the item and whether one of the purchase histories does not include the item.

According to embodiments, the advertising server 102 and/or the electronic devices 105, 106, 107 may further determine whether the item has a positive user experience for an associated user of the corresponding electronic device 105, 106, 107. In some cases, the advertising server 102 and/or the electronic devices 105, 106, 107 can examine a user profile page of the associated user within the social network server 101 to determine if the user has positively or negatively commented on the product. In other cases, the advertising server 102 and/or the electronic devices 105, 106, 107 can examine the purchase history in the inventory server 103 to determine when the item was purchased (and also how much time has elapsed since the purchase), if the associated user has returned or exchanged the item, or other relevant information.

In aspects, the advertising server 102 and/or the electronic devices 105, 106, 107 can determine that the item has a positive user experience for the associated user if (1) a certain amount of time has elapsed since the item was purchased and also that the certain amount of time does not exceed a predetermined limit (such that the user has had an ample amount of time to utilize the item), (2) the user has not returned or exchanged the item, (3) the user has positively commented on the item (such as via the social network server 101), or (4) relevant sensor data (e.g., NFC data, RFID data, or image sensor data) indicates that the user used the item for a sufficient or relevant amount of time (i.e., that the user has not used the item only briefly). It should be appreciated that other techniques for determining a positive user experience for an item are envisioned.

If the advertising server 102 and/or the electronic devices 105, 106, 107 determines that a purchase inventory of one of the electronic devices 105, 106, 107 has a particular item, that a purchase inventory of another of the electronic devices 105, 106, 107 does not have the particular item, and the item is associated with a positive user experience for a user of the one of the electronic devices 105, 106, 107, then the advertising server 102 can identify an advertisement associated with the item. In some cases, one of the electronic devices 105, 106, 107 can request the advertising server 102 to provide an advertisement for the item to one or more of the electronic devices 105, 106, 107, wherein the request can identify the item and specify which of the electronic devices 105, 106, 107 to send the advertisement.

The advertising server 102 can provide or send the advertisement to one or more of the electronic devices 105, 106, 107. In certain embodiments, the advertising server 102 can provide or send the advertisement to the electronic device that does not have the item in its purchase history, to the electronic device that has the item in its purchase history, and/or to any of the remaining electronic devices that are within the proximity 108. In further embodiments, the advertising server 102 can send a modified advertisement to the electronic device that has the item in its purchase history, wherein in some cases the modified advertisement can identify users of the electronic devices that have received the advertisement. The modified advertisement can also offer incentives for the user of the electronic device that has the item in its purchase history to promote the item to the other users of the electronic devices that have received the advertisement. For example, the modified advertisement can offer affinity points, rewards, discounts, and/or the like to the user who has the item when another user purchases the item.

In some embodiments, prior to the advertising server 102 sending the advertisement, the electronic devices 105, 106, 107 can determine that the users of the electronic devices 105, 106, 107 are conversing. In particular, one of the electronic devices 105, 106, 107 can detect a voice (e.g., via a microphone) of one or more of the users. In some cases, the electronic devices 105, 106, 107 can analyze the detected voice to identify a specific user of one of the devices. Responsive to detecting the voice, the corresponding electronic device can request the advertising server 102 to provide the advertisement to any of the electronic devices 105, 106, 107. In this way, the users are conversing shortly before or at the time when the advertising server 102 provides the advertisement to any of the electronic devices 105, 106, 107, where the advertisement can more easily elicit further conversation among the users.

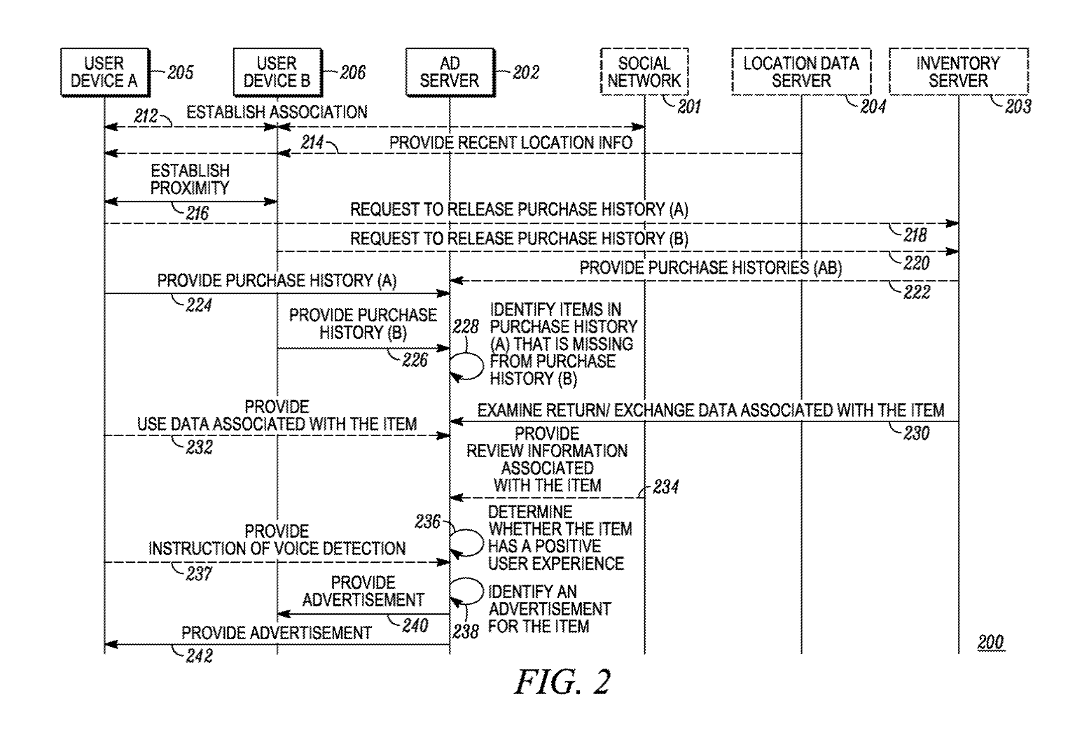

A diagram 200 illustrating various embodiments is depicted in FIG. 2. In FIG. 2, an advertising server 202 receives information from socially-associated, proximal user devices 205, 206 and compares this information to identify an appropriate mobile advertisement. As shown, the diagram 200 includes a user device A 205 (such as the electronic device 105 as discussed with respect to FIG. 1), a user device B 206 (such as the electronic device 106 as discussed with respect to FIG. 1), an advertising server 202 (such as the advertising server 102 as discussed with respect to FIG. 1), an optional social network server 201 (such as the social network server 101 as discussed with respect to FIG. 1), an optional location data server 204 (such as the location data server 104 as discussed with respect to FIG. 1), and an optional inventory server 203 (such as the inventory server 203 as discussed with respect to FIG. 1). The diagram 200 details functionality relating to the advertising server 202 determining that various conditions for identifying and providing an advertisement have been met.

According to embodiments, user device A 205, user device B 206, and the social network server 201 can optionally establish (212) a social connection or association. In some aspects, the respective users of user device A 205 and user device B 206 can be connected via the social network server 201. In other aspects, user device A 205 and user device B 206 can store identifications of each other in respective contact lists. The location data server 204 can optionally provide (214) respective recent or current location data to user device A 205 and/or user device B 206. According to embodiments, the components and entities of the diagram 200 can use the location data to determine proximity, identify relevant items, or determine any positive user experiences.

User device A 205 and user device B 206 can establish (216) a proximity to each other. According to embodiments, user device A 205 and user device B 206 can establish proximity via examining location or sensor data, via determining common network connectivity, or via other techniques, as discussed herein. User device A 205 can optionally request (218) the inventory server 203 to release a purchase history A associated with user device A 205, and user device B 206 can optionally request (220) the inventory server 203 to release a purchase history B associated with user device B 206. The purchase histories A, B can detail items or products that respective users of user device A 205 and user device B 206 have purchased or otherwise obtained. Responsive to receiving the requests, the inventory server 203 can optionally provide (222) the purchase histories A, B to the advertising server 202.

In another embodiment, the advertising server 202 may communicate, to the inventory server 203, a list of products of interest. Particularly, the list may include products that the advertising server 202 has contracted to provide advertising for or products that are otherwise to be preferentially advertised. The inventory server 203 may filter or partially filter any purchase histories according to the list of products of interest provided. In these embodiments, the resulting inventory list would be smaller and require less network resources to transmit than full purchase histories. The resulting inventory list would also have a higher incidence of products for which the advertising server 202 would have germane advertisements.

According to embodiments in which the devices locally store and maintain purchase histories, user device A 205 can provide (224) purchase history A to the advertising server 202 and user device B 206 can provide (226) purchase history B to the advertising server 202. The advertising server 202 can examine the purchase histories to identify (228) an item that is in purchase history A but is missing from purchase history B. Stated differently, the item can be one that a user of user device A 205 has purchased but a user of user device B 206 has not purchased.

In some embodiments, the advertising server 202 or the inventory server 203 can send a query to or otherwise request whether each of user device A 205 and user device B 206 has a particular item associated with a respective purchase history. In this way, the advertising server 202 or the inventory server 203 can have already identified an item for which an advertisement is available and, instead of receiving, sending, or examining entire purchase histories, the advertising server 202 or the inventory server 203 can query user device A 205 and user device B 206 with the identified item (and user device A 205 and user device B 206 can accordingly respond with a boolean value), thus reducing the amount of required bandwidth. For example, if the advertising server 202 has a particular video advertisement for an espresso machine, the advertising server 202 can query user device A 205 and user device B 206 to determine if the respective purchase histories include the espresso machine.

As discussed herein, it is advantageous if the user of user device A 205 has a positive user experience with the item identified in purchase history A. Accordingly, the inventory server 203 can provide (230) any return or exchange data associated with the item to the advertising server 202. Further, user device A 205 can optionally provide (232) use data associated with the item to the advertising server 202. In some cases, the use data can include NFC and/or RFID data that indicates an amount of use that the user has had with the item. For example, NFC data may indicate that the user has been often traveling or commuting in a recently-purchased motorcycle. Additionally, the social network server 201 can optionally provide (234) review information associated with the item. The review information can indicate positive or negative comments made by the user via the social network about the item. For example, the user may have commented, on a social network site, about a recent phone case purchase with “This new phone case is great!”

The advertising server 202 can determine (236) whether the item has a positive user experience. According to embodiments, the advertising server 202 can make the determination by analyzing the return/exchange data from the inventory server 203, the use data from user device A 205, and/or the review information from the social network server 201. If the item has a positive user experience, the advertising server 202 can identify (238) an advertisement for the item. It should be appreciated that the advertisement can be of any form such as, for example, a video, an image, a hyperlink, and/or or types or combinations of types or advertisements capable of being presented by a device. As shown in FIG. 2, user device A 205 can optionally provide (237) an indication of voice detection to the advertising server 202. In this case, user device A 205 may detect, via a microphone, the voice of the user of user device B 206, and the advertising server 202 can identify the advertisement responsive to receiving this indication of an on-going conversation.

The advertising server 202 can provide (240) the advertisement to user device B 206 and user device B 206 can display or otherwise present the advertisement. Further, the advertising server 202 can provide (242) the advertisement to user device A 205 and user device A 205 can display or otherwise present the advertisement. In some cases, the advertising server 202 can modify the advertisement before sending to user device A 205 or can otherwise send an alternative advertisement to user device A 205, such as an advertisement that indicates that user device B 206 has received the advertisement or an ad that offers incentives for promoting the item to the user of user device B 206. The providing of the advertisements can elicit conversation between the respective users of user device A 205 and user device B 206 about the item presented in the advertisement.

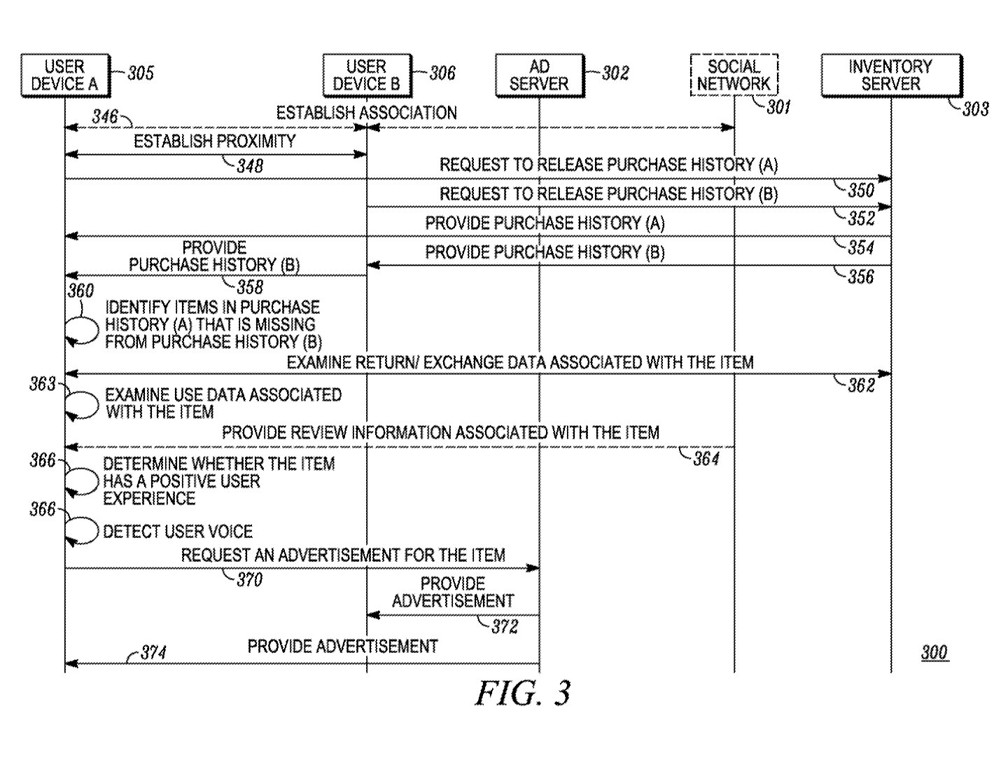

A diagram 300 illustrating various embodiments is depicted in FIG. 3. In FIG. 3, a mobile device A 305 receives information from another socially-associated, proximal user device B 306 (either directly from the mobile device B 306 or indirectly through an inventory server 303) and compares this information to request an appropriate mobile advertisement. As shown, the diagram 300 includes a user device A 305 (such as the electronic device 105 as discussed with respect to FIG. 1), a user device B 306 (such as the electronic device 106 as discussed with respect to FIG. 1), an advertising server 302 (such as the advertising server 102 as discussed with respect to FIG. 1), an optional social network server 301 (such as the social network server 101 as discussed with respect to FIG. 1), and an inventory server 303 (such as the inventory server 203 as discussed with respect to FIG. 1). The diagram 300 details functionality relating to user device A 305 determining that various conditions for identifying and providing an advertisement have been met.

According to embodiments, user device A 305, user device B 306, and the social network server 301 can optionally establish (346) a social connection or association. In some aspects, the respective users of user device A 305 and user device B 306 can be connected via the social network server 301. In other aspects, user device A 305 and user device B 306 can store identifications of each other in respective contact lists. User device A 305 and user device B 306 can establish (348) a proximity to each other. According to embodiments, user device A 305 and user device B 306 can establish proximity via examining location or sensor data, via determining common network connectivity, or via other techniques, as discussed herein.

User device A 305 can request (350) the inventory server 303 to release a purchase history A associated with user device A 305, and user device B 306 can request (352) the inventory server 303 to release a purchase history B associated with user device B 306. The purchase histories A, B can detail items or products that respective users of user device A 305 and user device B 306 have purchased or otherwise obtained. Responsive to receiving the requests, the inventory server 303 can provide (354) purchase history A to user device A 305 and can provide (356) purchase history B to user device B 306 (or in some cases to user device A 305). Further, user device B 306 can provide (358) purchase history B to user device A 305. As shown in FIG. 3, user device A 305 can examine purchase histories A and B to identify (360) an item that is in purchase history A but is missing from purchase history B. Stated differently, the item can be one that a user of user device A 305 has purchased but a user of user device B 306 has not purchased. In some embodiments, the respective user devices A, B 305, 306 can locally store respective purchase histories A, B.

As discussed herein, it is advantageous if the user of user device A 305 has a positive user experience with the item identified in purchase history A. Accordingly, the inventory server 303 can provide (362) any return or exchange data associated with the item to user device A 305. Further, user device A 305 can optionally examine (363) use data associated with the item. In some cases, the user data can include NFC and/or RFID data that indicates an amount of use that the user has had with the item. Additionally, the social network server 301 can optionally provide (364) review information associated with the item. The review information can indicate positive or negative comments made by the user of device A 305 via the social network about the item.

User device A 305 can determine (366) whether the item has a positive user experience. According to embodiments, user device A 305 can make the determination by analyzing the return/exchange data from the inventory server 303, the use data of user device A 305, and/or the review information from the social network server 301. If the item has a positive user experience, user device A 305 can request (370) the advertising server 302 for an advertisement for the item, the request identifying the item and a list of user devices that are to receive the advertisement. It should be appreciated that the advertisement can be of any form such as, for example, a video, an image, a hyperlink, and/or or types or combinations of types or advertisements capable of being presented by a device. As shown in FIG. 3, user device A 305 can optionally detect (368) a voice prior to requesting the advertisement. In this case, user device A 305 may detect, via a microphone, the voice of the user of user device B 306, and user device A 305 can request the advertisement responsive to the detection.

The advertising server 302 can provide (372) the advertisement to user device B 306 and user device B 306 can display or otherwise present the advertisement. Further, the advertising server 302 can provide (374) the advertisement to user device A 305 and user device A 305 can display or otherwise present the advertisement. In some cases, the advertising server 302 can modify the advertisement before sending to user device A 305 or can otherwise send an alternative advertisement to user device A 305, such as an advertisement that indicates that user device B 306 has received the advertisement or an advertisement that offers incentives for promoting the item to the user of user device B 306. The providing of the advertisements can elicit conversation between the respective users of user device A 305 and user device B 306 about the item presented in the advertisement.

This FIG. 2 provides a network-centric example of determining an appropriate advertisement for a group of mobile device users, and FIG. 3 provides a mobile-centric example of determining an appropriate advertisement for a group of mobile device users. Of course, both of these examples may use additional elements such as an advertising server, a social network, a location area server, and an inventory server. Note also that some of the server and network elements may be combined into a single server and also that some of these elements may be distributed over multiple servers.

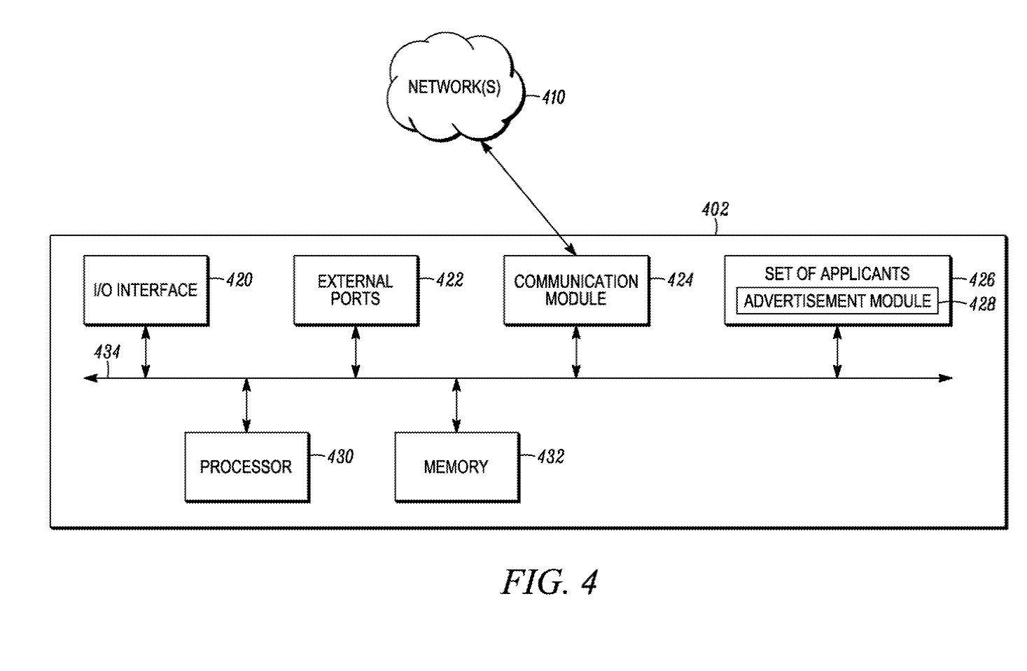

FIG. 4 illustrates an example advertising server 402 in which the embodiments may be implemented. The advertising server 402 can include a combination of hardware and software components. Particularly, the advertising server 402 includes a processor 430, a memory 432 (e.g., hard drives, flash memory, MicroSD cards, and others), and one or more external ports 422 (e.g., cellular input and output, Universal Serial Bus (USB), HDMI, IEEE 1394, and/or others). The advertising server 402 can further include a communication module 424 configured to interface with the one or more external ports 422 to communicate via one or more wired or wireless networks 410 such as, for example a WAN, LAN, PAN, and/or others. For example, the communication module 424 can include one or more transceivers (e.g., WWAN, WLAN, and/or WPAN transceivers) functioning in accordance with IEEE standards, 3 GPP standards, or other standards, and configured to receive and transmit data via the one or more external ports 422. The components of the advertising server 402 are capable of communicating with each other via a communication bus 434.

The advertising server 402 can further include an input/output (I/O) interface 420 capable of communicating with one or more input devices and external displays (not shown in figures) associated with presenting information to a user or administrator and/or receiving inputs from the user or administrator. As shown in FIG. 4, the advertising server 402 can further include a set of applications 426 that are configured to interface with other components of the advertising server 402 to facilitate the functionalities of the systems and methods as described herein. Particularly, the set of applications 426 can include an advertisement module 428 that can be capable of receiving advertisement requests from devices, identifying relevant advertisements, providing advertisements to devices, and/or performing other functions.

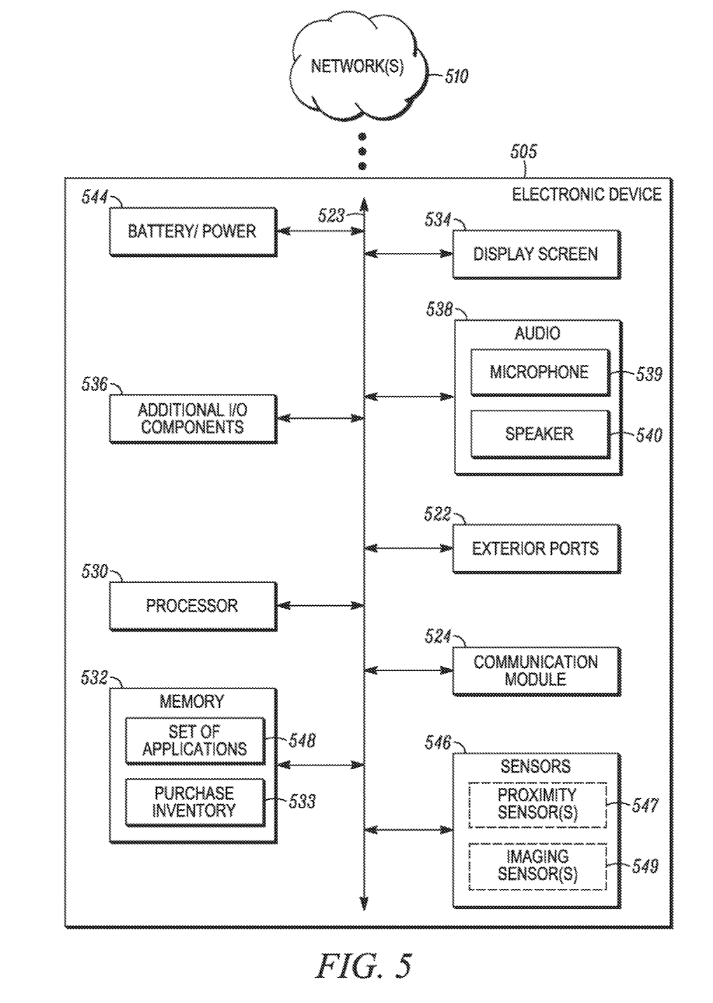

FIG. 5 illustrates an example electronic device 505 (such as user device A 105 as discussed with respect to FIG. 1) in which the aspects may be implemented. The electronic device 505 can include a processor 530, a memory 532 (e.g., hard drives, flash memory, MicroSD cards, and others), a power module 544 (e.g., batteries, wired or wireless charging circuits, etc.), and one or more external ports 522 (e.g., cellular input and output, Universal Serial Bus (USB), HDMI, IEEE 1394, and/or others), each configured to communicate via a communication bus 523. The processor 530 can interface with the memory 532 to execute a set of applications 548 capable of facilitating the functionalities as discussed herein. As shown in FIG. 5, the memory 532 can store a purchase inventory 533 that details item purchases associated with the electronic device 505.

The electronic device 505 can further include a communication module 524 configured to interface with the one or more external ports 522 to communicate data via one or more networks 510. For example, the communication module 524 can include one or more transceivers functioning in accordance with IEEE standards, 3GPP standards, or other standards, and configured to receive and transmit data via the one or more external ports 522. More particularly, the communication module 524 can include one or more WWAN transceivers configured to communicate with a wide area network including one or more cell sites or base stations to communicatively connect the electronic device 505 to additional devices or components. Further, the communication module 524 can include one or more WLAN and/or WPAN transceivers configured to connect the electronic device 505 to local area networks and/or personal area networks, such as a Bluetooth® network.

The electronic device 505 can further include one or more sensors 546 such as, for example, proximity sensors 547 (e.g., NFC sensors or RFID chips), imaging sensors 549, and/or other sensors. The electronic device 505 can include an audio module 538 including hardware components such as a speaker 540 for outputting audio and a microphone 539 for receiving audio. The electronic device 505 may further include one or more display screen 534, and additional I/O components 536 (e.g., touch sensitive input, keys, buttons, lights, LEDs, cursor control devices, haptic devices, and others). The display screen 534 and the additional I/O components 536 may be considered to form portions of a user interface (e.g., portions of the electronic device 505 associated with presenting information to the user and/or receiving inputs from the user).

In embodiments, the display screen 534 is a touchscreen display using singular or combinations of display technologies such as electrophoretic displays, electronic paper, polyLED displays, OLED displays, AMOLED displays, liquid crystal displays, electrowetting displays, rotating ball displays, segmented displays, direct drive displays, passive-matrix displays, active-matrix displays, and/or others. Further, the display screen 534 can include a thin, transparent touch sensor component superimposed upon a display section that is viewable by a user. For example, such displays include capacitive displays, resistive displays, surface acoustic wave (SAW) displays, optical imaging displays, and the like.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 530 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

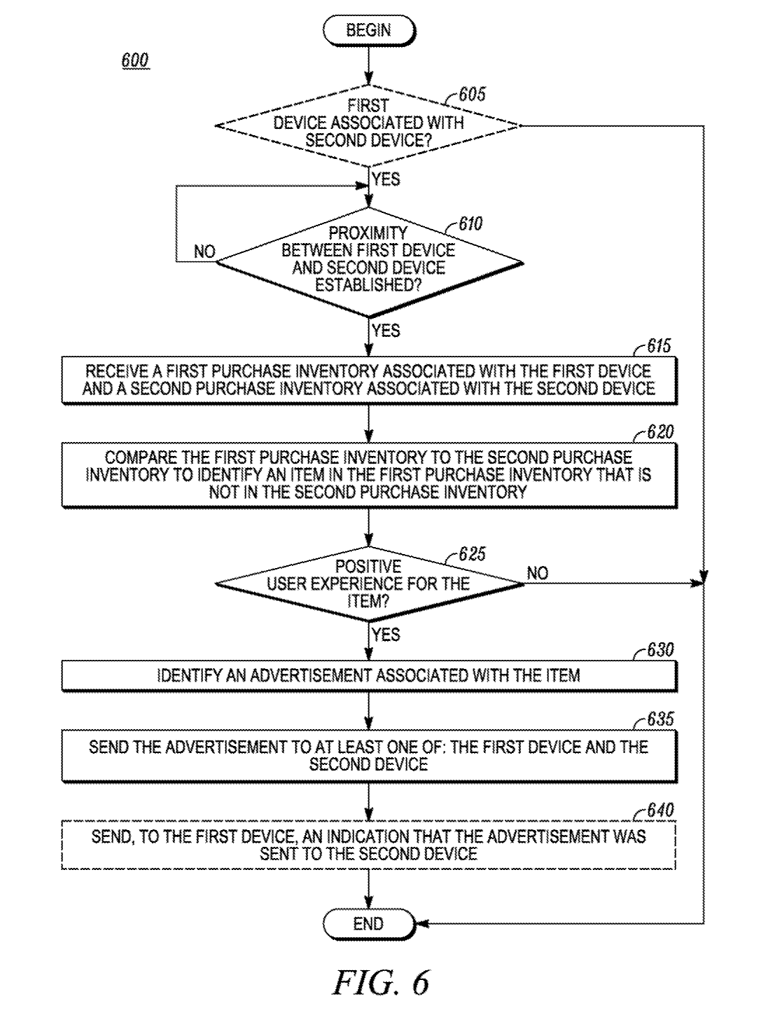

FIG. 6 is a flowchart of a method 600 for a computing device (such as the advertising server 102 as described with respect to FIG. 1) to provide an advertisement to one or more devices. More particularly, the advertisement is for an item that is associated with one of the devices. FIG. 6 may be used with the diagram of FIG. 2 to implement a network-centric version of advertising to a group of mobile users.

The method 600 begins with the computing device optionally determining 605 whether a first device is associated with a second device. In embodiments, the association can be via a social network or via respective contacts lists of the first device and the second device. If the first device is not associated with the second device (“NO”), then processing can end. If the first device is associated with the second device (“YES”), then the computing device determines 610 whether the first device is in proximity to the second device. The proximity can be determined via an analysis of various sensor or network data, or via receiving an indication from the first device or the second device indicating that proximity is established. If proximity is not established (“NO”), then processing can pause until proximity is established.

If proximity is established (“YES”), then the computing device receives 615 a first purchase inventory associated with the first device and a second purchase inventory associated with the second device. In embodiments, the purchase inventories can be received from the first and second devices or from an inventory server, and the purchase inventories can identify listings of products that are associated with the first and second devices and the users thereof. The computing device compares 620 the first purchase inventory to the second purchase inventory to identify an item in the first purchase inventory that is not in the second purchase inventory. In other words, a user of the first device has purchased the item and a user of the second device has not purchased the item.

The computing device determines 625 if the item has a positive user experience for the user of the first device. In embodiments, the determination can be made via examining social network data, return or exchange history data, and/or sensor data, as discussed herein. If the item does not have a positive user experience for the user of the first device (“NO”), then processing can end. If the item has a positive user experience for the user of the first device (“YES”), the computing device identifies 630 an advertisement associated with the item. It should be appreciated that the advertisement can be any advertisement capable of being displayed or presented by a device.

The computing device sends 635 the advertisement to at least one of: the first device and the second device. More particularly, the computing device can send the advertisement to the first device, the second device, or both the first device and the second device. In some optional embodiments, the computing device sends 640, to the first device, an indication that the advertisement was sent to the second device. In embodiments, the computing device can also offer incentives to the user of the first device if the user of the second device accesses the advertisement and purchases the item or otherwise redeems an offer specified in the advertisement.

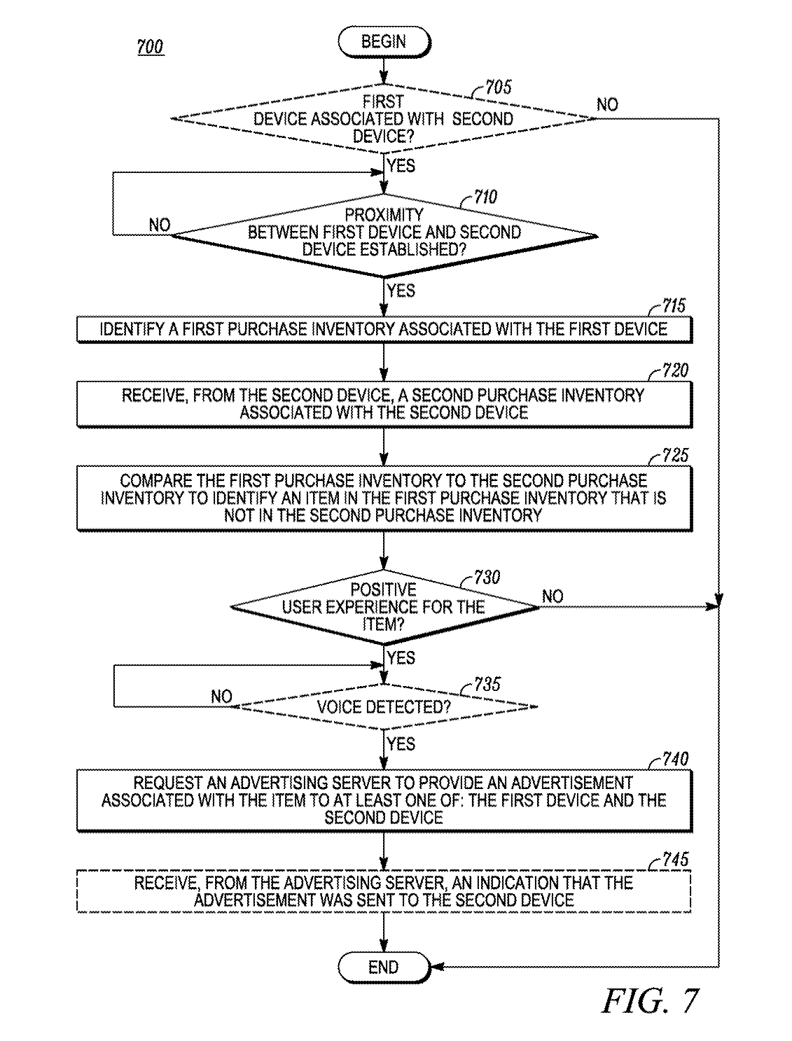

FIG. 7 is a flowchart of a method 700 for a first device (such as user device A 105 as described with respect to FIG. 1) to facilitate the requesting of an advertisement. More particularly, the advertisement is for an item that is associated with the first device. FIG. 7 may be used with the diagram of FIG. 3 to implement a mobile-centric version of advertising to a group of mobile users.

The method 700 begins with the first device optionally determining 705 whether the first device is associated with a second device. In embodiments, the association can be via a social network or via respective contacts lists of the first device and the second device. If the first device is not associated with the second device (“NO”), then processing can end. If the first device is associated with the second device (“YES”), then the first device determines 710 whether the first device is in proximity to the second device. The proximity can be determined via an analysis of various sensor or network data, or via receiving an indication from one of the first device or the second device indicating that proximity is established. If proximity is not established (“NO”), then processing can pause until proximity is established.

If proximity is established (“YES”), then the first device identifies 715 a first purchase inventory associated with the first device. Further, the first device receives 720, from the second device, a second purchase inventory associated with the second device. In embodiments, the purchase inventories can be received directly from the devices or indirectly from an inventory server, and the purchase inventories can identify listings of products that are associated with the first and second devices and the users thereof. The first device compares 725 the first purchase inventory to the second purchase inventory to identify an item in the first purchase inventory that is not in the second purchase inventory. In other words, a user of the first device has purchased the item and a user of the second device has not purchased the item.

The first device determines 730 if the item has a positive user experience for the user of the first device. In embodiments, the determination can be made via examining social network data, return or exchange history data, and/or sensor data, as discussed herein. If the item does not have a positive user experience for the user of the first device (“NO”), then processing can end. If the item has a positive user experience for the user of the first device (“YES”), the first device optionally determines 735 if a voice has been detected. More particularly, a microphone of the first device can detect voice data of a user of the second device. If the voice is not detected (“NO”), then processing can pause until the voice is detected.

If the voice is detected (“YES”), then the first device requests 740 an advertising server to provide an advertisement associated with the item to at least one of: the first device and the second device. More particularly, the advertising server can send the advertisement to the first device, the second device, or both the first device and the second device. It should be appreciated that the advertisement can be any advertisement capable of being displayed or presented by a device. In some optional embodiments, the first device receives 745, from the advertising server, an indication that the advertisement was sent to the second device. In embodiments, the advertising server can also offer incentives to the user of the first device if the user of the second device accesses the advertisement and purchases the item or otherwise redeems an offer specified in the advertisement.

Thus, it should be clear from the preceding disclosure that the systems and methods offer improved advertising strategies. The systems and methods advantageously allow companies and entities to more accurately target consumers with advertisements that more easily elicit conversation among the recipients. Further, the systems and methods advantageously allow advertising providers to charge more for advertisements related to items that are possessed by some recipients (and have positive user experiences with such consumers) and are not possessed by other recipients.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method in a first communication device of advertising, the method comprising:
determining that the first communication device is in proximity to a second communication device;
identifying a first purchase inventory associated with the first communication device;
receiving, from the second communication device, a second purchase inventory associated with the second communication device;
comparing, by a processor, the first purchase inventory to the second purchase inventory to identify an item in the first purchase inventory that is not in the second purchase inventory, the item associated with a positive user experience for a user of the first communication device; and
requesting a server to provide an advertisement associated with the item to at least one of:
the first communication device and the second communication device.

2. The method of claim 1, wherein the comparing the first purchase inventory to the second purchase inventory comprises:
identifying the item in the first purchase inventory;
determining that the item is not in the second purchase inventory; and
examining the first purchase inventory to identify an elapsed period of time from when the item was purchased, wherein the elapsed period of time is within a predefined range.

3. The method of claim 1, further comprising after the requesting:
receiving, from the server, an indication that the advertisement was sent to the second communication device.

4. The method of claim 1, wherein the first communication device is associated with the second communication device via at least one of: a contacts list and a social network.

5. The method of claim 1, wherein the identifying the first purchase inventory comprises:
analyzing sensor data of the first communication device to identify the item; and
accessing the first purchase inventory to determine that the item is included in the first purchase inventory.

6. The method of claim 1, further comprising determining that the item is associated with the positive user experience via at least one of:
(i) examining a social network associated with the user of the first communication device to determine that the item does not have an associated negative review by the user of the first communication device,
(ii) determining that the item has not been returned or exchanged by the user of the first communication device, and
(iii) examining sensor data of the first communication device to determine that the item has experienced extensive use by the user of the first communication device.

7. The method of claim 1, wherein the identifying the first purchase inventory comprises:
responsive to the determining, requesting an inventory server to provide the first purchase inventory; and
receiving the first purchase inventory from the inventory server.

8. The method of claim 1, wherein the requesting the server to provide the advertisement comprises:
detecting a voice other than that of the user of the first communication device; and
responsive to the detecting, requesting the server to provide the advertisement associated with the item to the at least one of: the first communication device and the second communication device.

9. A method in a network device of advertising, the method comprising:
determining that a first communication device is in proximity to a second communication device;
receiving a first purchase inventory associated with the first communication device and a second purchase inventory associated with the second communication device;
comparing the first purchase inventory to the second purchase inventory to identify an item in the first purchase inventory that is not in the second purchase inventory, the item having a positive user experience for a user of the first communication device;
identifying an advertisement associated with the item; and
sending the advertisement to at least one of: the first communication device and the second communication device.

10. The method of claim 9, wherein the first communication device is associated with the second communication device via at least one of: a contacts list and a social network.

11. The method of claim 9, wherein the first purchase inventory and the second purchase inventory are (i) respectively received from the first communication device and the second communication device, or (ii) received from at least one remote server storing the first purchase inventory and the second purchase inventory.

12. The method of claim 9, further comprising:
sending, to the first communication device, an indication that the advertisement was sent to the second communication device.

13. The method of claim 9, wherein the comparing the first purchase inventory to the second purchase inventory comprises:
identifying the item in the first purchase inventory;
determining that the item is not in the second purchase inventory; and
examining the first purchase inventory to identify an elapsed period of time from when the item was purchased, wherein the elapsed period of time is within a predefined range.

14. The method of claim 9, wherein the receiving the first purchase inventory comprises:
receiving sensor data from the first communication device;
analyzing the sensor data to identify the item; and
accessing the first purchase inventory to determine that the item is included in the first purchase inventory.

15. The method of claim 9, further comprising determining that the item is associated with the positive user experience via at least one of:
(i) examining a social network associated with the user of the first communication device to determine that the item does not have an associated negative review by the user of the first communication device,
(ii) determining that the item has not been returned or exchanged by the user of the first communication device, and
(iii) examining sensor data of the first communication device to determine that the item has experienced extensive or continuous use by the user of the first communication device.

16. An electronic device comprising:
a communication module capable of communicating data; and
a processor coupled to the communication module, the processor configured to perform operations comprising:
determining that the electronic device is in proximity to an additional electronic device,
identifying a first purchase inventory associated with the electronic device,
receiving, from the additional electronic device, via the communication module, a second purchase inventory associated with the additional electronic device,
comparing the first purchase inventory to the second purchase inventory to identify an item in the first purchase inventory that is not in the second purchase inventory, the item associated with a positive user experience for a user of the electronic device, and
requesting a server via the communication module to provide an advertisement associated with the item to at least one of: the electronic device and the additional electronic device.

17. The electronic device of claim 16, wherein the comparing the first purchase inventory to the second purchase inventory comprises:
identifying the item in the first purchase inventory,
determining that the item is not in the second purchase inventory, and
examining the first purchase inventory to identify an elapsed period of time from when the item was purchased, wherein the elapsed period of time is within a predefined range.

18. The electronic device of claim 16, further comprising:
a sensor capable of generating sensor data associated with the item, and wherein the identifying the first purchase inventory comprises:
analyzing the sensor data to identify the item; and
accessing the first purchase inventory to determine that the item is included in the first purchase inventory.

19. The electronic device of claim 16, further comprising:
a sensor capable of generating sensor data associated with the item, and wherein the processor is further configured to perform operations comprising:
determining that the item is associated with the positive user experience via at least one of:
(i) examining a social network associated with the user to determine that the item does not have an associated negative review by the user of the electronic device,
(ii) determining that the item has not been returned or exchanged by the user of the electronic device, and
(iii) examining sensor data to determine that the item has experienced extensive use by the user of the electronic device.

20. The electronic device of claim 16, further comprising:
a microphone capable of detecting audio, and wherein the requesting the server to provide the advertisement comprises:
analyzing the audio detected by the microphone to identify a voice other than that of the user of the electronic device, and
responsive to the detecting, requesting the server via the communication module to provide the advertisement associated with the item to the at least one of: the electronic device and the additional electronic device.
